(19) United States
(12) Patent Application Publication
(10) Pub. No.: US 2026/0312114 A1
(43) Pub. Date: Oct. 8, 2026

(54) Electrode Stack And Battery System Including Electrode Stack

(71) Applicant: LG Energy Solution, Ltd., Seoul (KR)

(72) Inventors: Jae Hyeok Choi, Daejeon (KR); Sung Hyun Kim, Daejeon (KR); Dong Hun Song, Daejeon (KR); Ki Hyun Park, Daejeon (KR); Xu Yang, Daejeon (KR); Soo Hwang Lee, Daejeon (KR)

(73) Assignee: LG Energy Solution, Ltd., Seoul (KR)

(21) Appl. No.: 19/484,072

(22) PCT Filed: Jun. 20, 2024
(86) PCT No.: PCT/KR2024/008528

§ 371 Date: Nov. 13, 2025

(30) Foreign Application Priority Data
Jun. 28, 2023 (KR) 10-2023-0083720

(51) Int. Cl. H01M 10/04

(52) U.S. Cl. CPC H01M 10/0413; H01M 10/049

(57) ABSTRACT

An electrode stack may include: (1) a first electrode sub-stack; and a second electrode sub-stack disposed on top of the first electrode sub-stack and formed in a different shape from the first electrode sub-stack when viewed from above the second electrode sub-stack. The first electrode sub-stack and the second electrode sub-stack may be bent along a stacking direction. A battery system may include: (1) a battery unit having a bending portion in a bent shape that defines a receiving space for accommodating an electrode stack therein; and the electrode stack disposed in the receiving space.

### CROSS-REFERENCE TO RELATED APPLICATIONS

The present application is a national phase entry under 35 U.S.C. § 371 of International Application No. PCT/KR2024/008528, which was filed on Jun. 20, 2024 and claims priority to Korean Patent Application No. 10-2023-0083720 filed on Jun. 28, 2023 in the Republic of Korea, all of which are incorporated herein by reference.

### TECHNICAL FIELD

The present disclosure relates to an electrode stack and a battery system including the electrode stack.

### BACKGROUND

In order to address the high demand for new energy sources due to the depletion of petroleum resources and to solve the increasingly severe problem of environmental pollution, research and development on electric power generation based on eco-friendly energy sources are in progress. In particular, research on secondary batteries that can be repeatedly charged and discharged is being actively conducted, and various aspects such as materials, structures, processes, and stability of secondary batteries are being studied.

The secondary battery may include an electrode stack. In particular, when the density of the electrode stack itself is high or the electrode stack is mounted at a high density, energy efficiency may be increased and space efficiency may be maximized. The secondary battery may have an external shape corresponding to the shape of the electrode stack.

According to the prior art, simply mounting a secondary battery within a battery system (e.g., an electronic device) may degrade space efficiency and may not ensure sufficient battery capacity.

### SUMMARY

### Technical Problem

The present disclosure is designed to solve the problems of the related art, and therefore the present disclosure is directed to providing an electrode stack capable of maximizing space efficiency and battery capacity, and a battery system including the electrode stack.

### Technical Solution

An electrode stack according to an aspect of the present disclosure may include a first electrode stack, and a second electrode stack disposed on top of the first electrode stack and formed in a different shape from the first electrode stack when viewed from above, wherein the first electrode stack and the second electrode stack may be bent along the stacking direction.

A battery system according to an aspect of the present disclosure may include a battery unit having a bending portion in a bent shape that defines a receiving space for accommodating an electrode stack therein, and an electrode stack disposed in the receiving space, wherein the electrode stack may include a first electrode stack, and a second electrode stack disposed on top of the first electrode stack and formed in a different shape from the first electrode stack when viewed from above, wherein the first electrode stack and the second electrode stack may be bent along the stacking direction.

### Advantageous Effects

According to a preferred aspect of the present disclosure, space efficiency within the battery system may be maximized.

According to a preferred aspect of the present disclosure, usable battery capacity may be maximized.

### DESCRIPTION OF THE DRAWINGS

FIG. 1 is a plan view of an electrode stack according to a first aspect of the present disclosure.

FIG. 2 is a side view of an electrode stack according to a first aspect of the present disclosure.

FIG. 3 is a perspective view of an electrode stack according to a first aspect of the present disclosure.

FIG. 4 is a plan view of an electrode stack according to a second aspect of the present disclosure.

FIG. 5 is a side view of an electrode stack according to a second aspect of the present disclosure.

FIG. 6 is a perspective view of an electrode stack according to a second aspect of the present disclosure.

FIG. 7 is a plan view of an electrode stack according to a third aspect of the present disclosure.

FIG. 8 is a side view of an electrode stack according to a third aspect of the present disclosure.

FIG. 9 is a perspective view of an electrode stack according to a third aspect of the present disclosure.

FIG. 10 is a plan view of an electrode stack according to a fourth aspect of the present disclosure.

FIG. 11 is a side view of an electrode stack according to a fourth aspect of the present disclosure.

FIG. 12 is a perspective view of an electrode stack according to a fourth aspect of the present disclosure.

FIG. 13 is a plan view of an electrode stack according to a fifth aspect of the present disclosure.

FIG. 14 is a side view of an electrode stack according to a fifth aspect of the present disclosure.

FIG. 15 is a perspective view of an electrode stack according to a fifth aspect of the present disclosure.

FIG. 16 is a plan view of an electrode stack according to a sixth aspect of the present disclosure.

FIG. 17 is a side view of an electrode stack according to a sixth aspect of the present disclosure.

FIG. 18 is a perspective view of an electrode stack according to a sixth aspect of the present disclosure.

FIG. 19 is a conceptual view showing a battery system according to an aspect of the present disclosure.

### DETAILED DESCRIPTION

Hereinafter, preferred aspects of the present disclosure will be described in sufficient detail with reference to the accompanying drawings to enable those having ordinary skill in the technical field pertaining to the present disclosure to easily carry out the present disclosure. However, the present disclosure may be embodied in many different forms and is not limited or restricted by the following aspects.

To clearly describe the present disclosure, an irrelevant description or a detailed description of related known technology that may unnecessarily obscure the gist of the present disclosure is omitted, and in affixing the reference numerals to the elements in each drawing, the identical or similar reference numerals are affixed to the identical or similar elements throughout the specification.

Additionally, it should be understood that the terms or words used in the specification and the appended claims should not be construed as limited to general and dictionary meanings, but rather interpreted based on the meanings and concepts corresponding to the technical aspect of the present disclosure on the basis of the principle that the inventor is allowed to define terms appropriately for the best explanation.

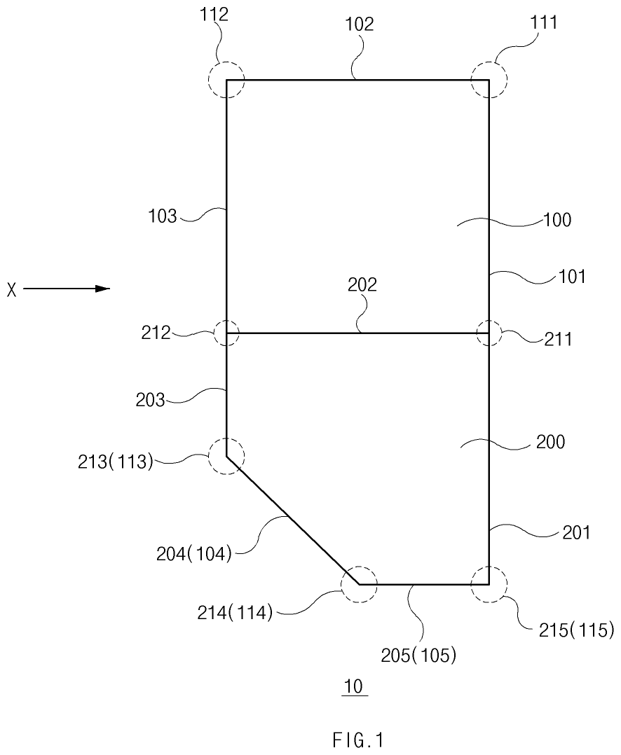

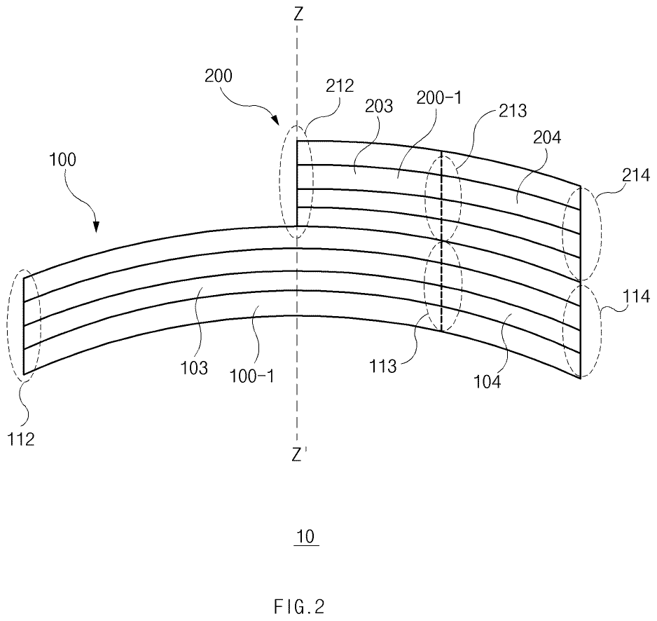

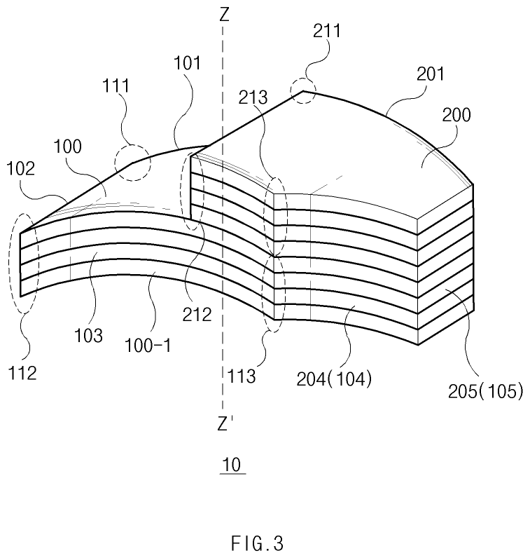

FIG. 1 is a plan view of an electrode stack according to a first aspect of the present disclosure, FIG. 2 is a side view of an electrode stack according to a first aspect of the present disclosure in the X direction, and FIG. 3 is a perspective view of an electrode stack according to a first aspect of the present disclosure.

The electrode stack 10 may include a first electrode stack 100 and a second electrode stack 200.

The first electrode stack 100 may be formed by stacking electrodes 100-1, and the second electrode stack 200 may be formed by stacking electrodes 200-1.

The first electrode stack 100 and the second electrode stack 200 may be in a stacked form.

The second electrode stack 200 may be disposed on top of the first electrode stack 100.

The second electrode stack 200 may be formed in a different shape from the first electrode stack 100 when viewed from above.

The second electrode stack 200 may have a smaller size than the first electrode stack 100. For example, the second electrode stack 200 may have a smaller area than the first electrode stack 100 when viewed from above.

The second electrode stack 200 may include edges that overlap edges of the first electrode stack 100. For example, the second electrode stack 200 may have a smaller area than the first electrode stack 100, and may have edges that overlap some of the edges of the first electrode stack 100.

The second electrode stack 200 may have a smaller area in a different shape from the first electrode stack 100 when viewed from above.

At least one of the first electrode stack 100 and the second electrode stack 200 may have corner portions formed in different shapes when viewed from above.

The first electrode stack 100 may include corner portions 111, 112, 113, 114, 115.

The corner portions 111, 112, 113, 114, 115 may include intersecting corner portions. For example, the intersecting corner portion may be a corner portion formed in a shape where straight lines intersect at a predetermined angle when viewed from above.

The corner portions 111, 112, 113, 114, 115 may include a plurality of obtuse intersecting corner portions. Specifically, for example, some corner portions 113, 114 among the corner portions 111, 112, 113, 114, 115 may be obtuse intersecting corner portions provided by straight lines forming an obtuse angle when viewed from above. Additionally, the other corner portions 111, 112, 115 among the corner portions 111, 112, 113, 114, 115 may be intersecting corner portions in which straight lines are orthogonal when viewed from above.

The description of the corner portions 111, 112, 113, 114, 115 of first electrode stack 100 described above may also be applied to the corner portions 211, 212, 213, 214, 215 of the second electrode stack 200 to be described later.

The first electrode stack 100 may include side surfaces 101, 102, 103, 104, 105. The side surfaces 101, 102, 103, 104, 105 may form the lateral periphery of the electrodes 100-1. Additionally, the side surfaces 101, 102, 103, 104, 105 may connect the upper and lower surfaces of the first electrode stack 100 along the stacking direction Z-Z′.

The side surfaces 101, 102, 103, 104, 105 may be divided by the corner portions 111, 112, 113, 114, 115.

The side surfaces 101, 102, 103, 104, 105 may include a plurality of planes. For example, the side surfaces 101, 102, 103, 104, 105 may include a plurality of planes divided by the corner portions 111, 112, 113, 114, 115.

The second electrode stack 200 may include side surfaces 201, 202, 203, 204, 205. The side surfaces 201, 202, 203, 204, 205 may form the lateral periphery of the electrodes 200-1. Additionally, the side surfaces 201, 202, 203, 204, 205 may connect the upper and lower surfaces of the second electrode stack 200 along the stacking direction Z-Z′.

The side surfaces 201, 202, 203, 204, 205 may be divided by the corner portions 211, 212, 213, 214, 215.

The side surfaces 201, 202, 203, 204, 205 may include a plurality of planes. For example, the side surfaces 201, 202, 203, 204, 205 may include a plurality of planes divided by corner portions 211, 212, 213, 214, 215.

The first electrode stack 100 and the second electrode stack 200 may be bent along the stacking direction Z-Z′. For example, the first electrode stack 100 and the second electrode stack 200 may be bent in one direction along the stacking direction at a predetermined curvature. The first electrode stack 100 and the second electrode stack 200 may be bent in one direction (e.g., upward) along the stacking direction Z-Z′ as the electrodes 100-1 and the electrodes 200-1 are bent.

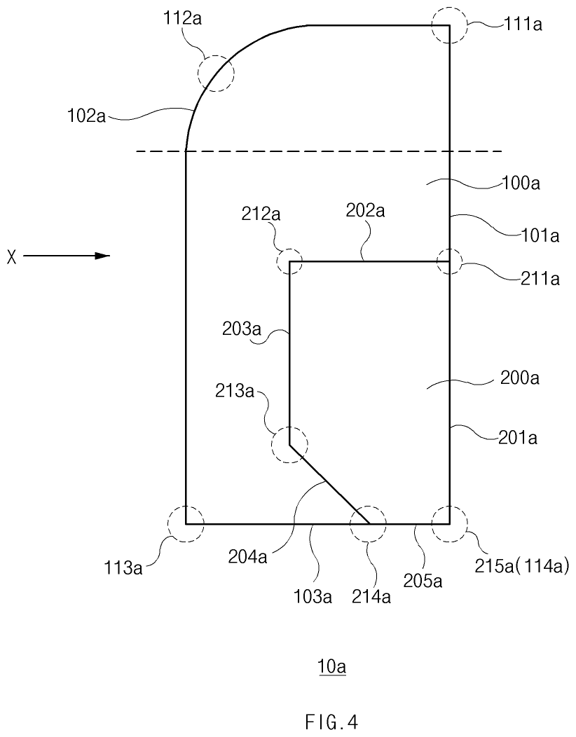

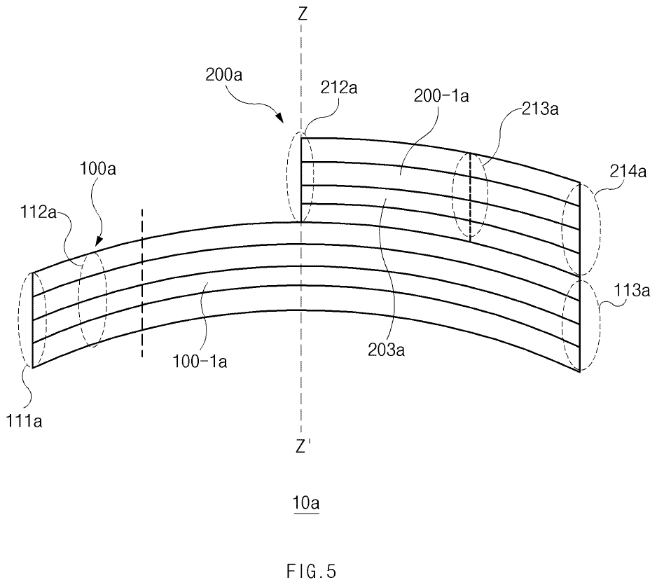

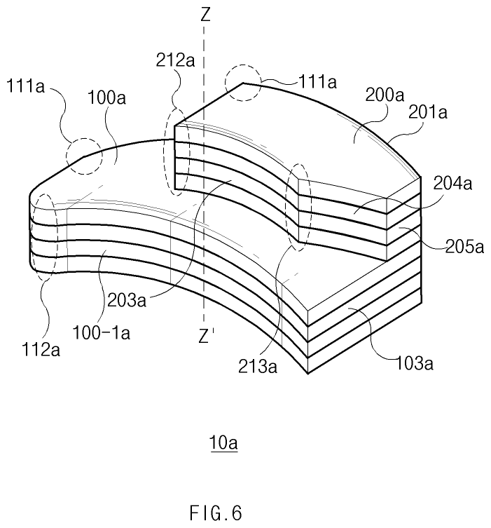

FIG. 4 is a plan view of an electrode stack according to a second aspect of the present disclosure, FIG. 5 is a side view of an electrode stack according to a second aspect of the present disclosure in the X direction, and FIG. 6 is a perspective view of an electrode stack according to a second aspect of the present disclosure. The description of the above-described aspect may also be applied equally or similarly to this aspect.

At least one of the first electrode stack 100a and the second electrode stack 200a may have corner portions formed in different shapes when viewed from above. For example, the first electrode stack 100a may include corner portions 111a, 112a, 113a, 114a.

The corner portions 111a, 112a, 113a, 114a may include a curved corner portion 112a. The curved corner portion 112a may be a corner portion provided in a curved shape when viewed from above.

The side surfaces 101a, 102a, 103a may include flat and curved surfaces. For example, the first electrode stack 100a may include flat side surfaces 101a, 103a and a curved side surface 102a.

The corner portions 111a, 112a, 113a, 114a may include intersecting corner portions 111a, 113a, 114a and a curved corner portion 112a.

When viewed from above, the intersecting corner portions 111a, 113a, 114a may be provided by straight lines that intersect at a predetermined angle, and the curved corner portion 112a may be provided in a curved line. Specifically, when viewed from above, the curved corner portion 112a may be formed in a curved shape between the intersecting corner portion 111a and the intersecting corner portion 113a. In other words, when the first electrode stack 100a is viewed from above, only the portion corresponding to the curved corner portion 112a on the rectangular upper surface may be formed in a curved shape.

According to the above description, the first electrode stack 100a has been described as having one curved corner portion 112a, but may not be limited thereto. For example, the first electrode stack 100a may also have a plurality of curved corner portions.

The second electrode stack 200a may include corner portions 211a, 212a, 213a, 214a, 215a.

The corner portions 211a, 212a, 213a, 214a, 215a may be formed in different shapes when viewed from above.

The corner portions 211a, 212a, 213a, 214a, 215a may include intersecting corner portions. For example, the intersecting corner portion may be a corner portion formed in a shape where straight lines intersect at a predetermined angle when viewed from above.

Some corner portions 211a, 212a, 215a among the corner portions 211a, 212a, 213a, 214a, 215a may be formed in a shape where straight lines are orthogonal to each other. The other corner portions 213a, 214a among the corner portions 211a, 212a, 213a, 214a, 215a may be formed in a shape where straight lines form a predetermined angle other than a right angle.

Specifically, the intersecting corner portion may include obtuse intersecting corner portions 213a, 214a. For example, the obtuse intersecting corner portions 213a, 214a may be corner portions formed in a shape where straight lines intersect at an obtuse angle. The intersecting corner portion may include a plurality of obtuse intersecting corner portions 213a, 214a.

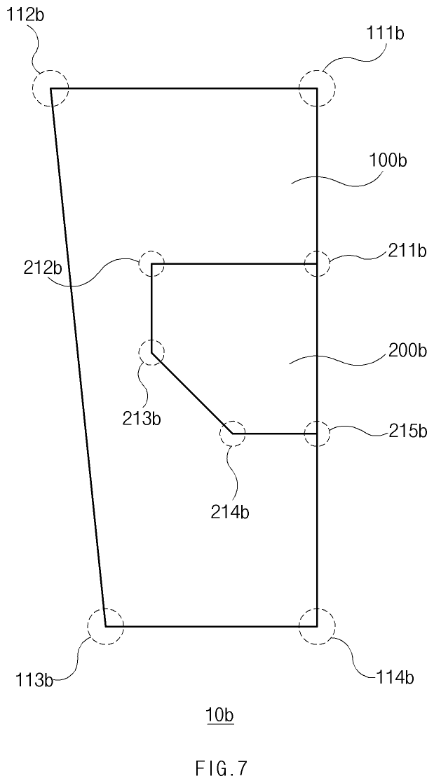

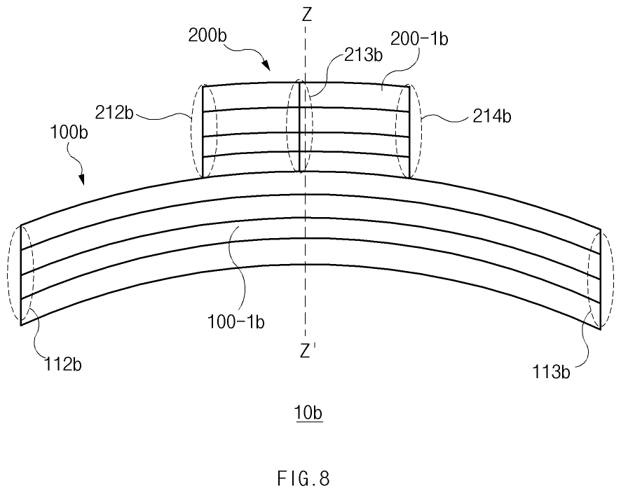

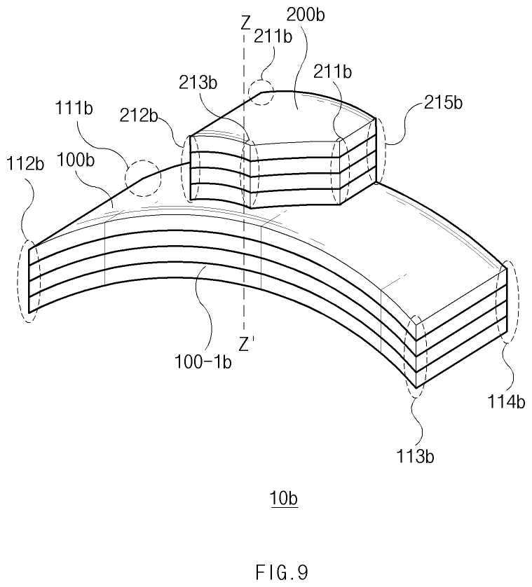

FIG. 7 is a plan view of an electrode stack according to a third aspect of the present disclosure, FIG. 8 is a side view of an electrode stack according to a third aspect of the present disclosure in the X direction, and FIG. 9 is a perspective view of an electrode stack according to a third aspect of the present disclosure. The description of the above-described aspect may also be applied equally or similarly to this aspect.

As for the shape of the second electrode stack 200b, the description of the second electrode stack 200a described with reference to FIG. 4, FIG. 5, and FIG. 6 may be applied. However, the second electrode stack 200b may have a shorter length of an edge that overlaps the first electrode stack 100b when compared with the second electrode stack 200a. For example, the edge portion where the second electrode stack 200b and the first electrode stack 100b overlap may be an edge connecting the corner portion 211b and the corner portion 215b among the edges of the second electrode stack 200b. The edge connecting the corner portion 211b and the corner portion 215b may partially overlap the edge connecting the corner portion 111b and the corner portion 114b.

The first electrode stack 100b may include corner portions 111b, 112b, 113b, 114b.

The corner portions 111b, 112b, 113b, 114b of the first electrode stack 100b may be intersecting corner portions.

The corner portions 111b, 112b, 113b, 114b of the first electrode stack 100b may include an acute intersecting corner portion and an obtuse intersecting corner portion.

The acute intersecting corner portion 112b may be a corner portion where straight lines intersect at an acute angle when viewed from above. The obtuse intersecting corner portion 113b may be a corner portion where straight lines intersect at an obtuse angle when viewed from above. The acute angle and the obtuse angle described above may be based on the inner angle of the first electrode stack 100b when viewed from above. In other words, when viewed from above, the first electrode stack 100b may have a trapezoidal shape.

The description of the electrode stacks 10, 10a, 10b described with reference to FIG. 1, FIG. 2, FIG. 3, FIG. 4, FIG. 5, FIG. 6, FIG. 7, FIG. 8, and FIG. 9 is an example and is not limited thereto. Specifically, the corner portions of the electrode stacks may be designed in various ways by combining intersecting corner portions and/or curved corner portions.

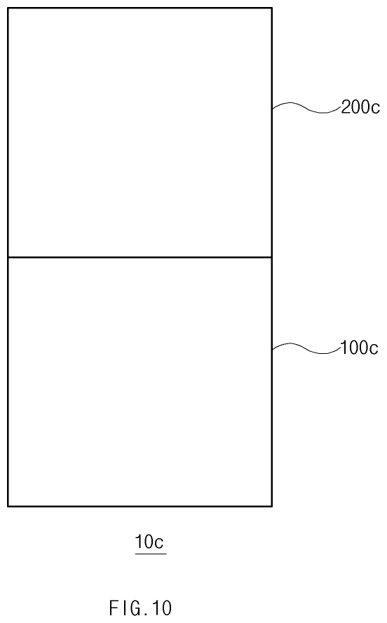

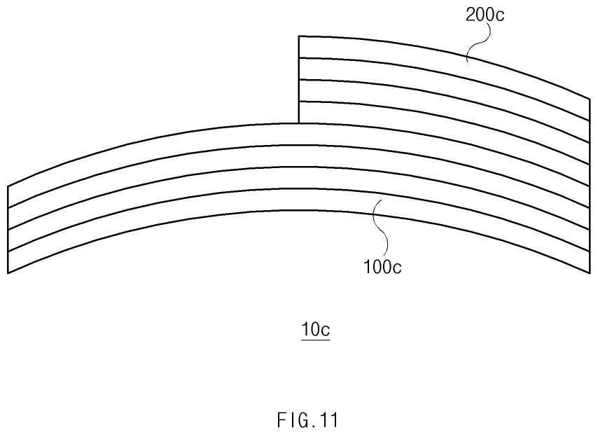

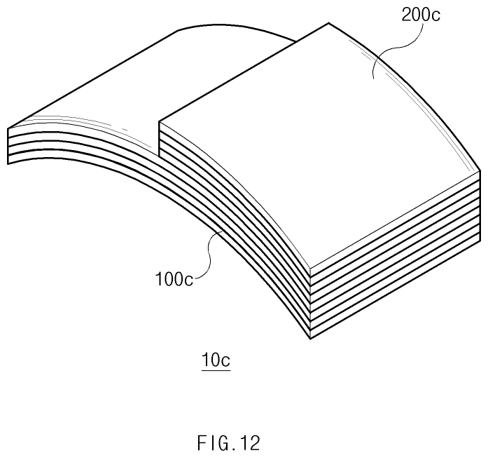

FIG. 10 is a plan view of an electrode stack according to a fourth aspect of the present disclosure, FIG. 11 is a side view of an electrode stack according to a fourth aspect of the present disclosure, and FIG. 12 is a perspective view of an electrode stack according to a fourth aspect of the present disclosure.

The electrode stack 10c may include a first electrode stack 100c and a second electrode stack 200c.

The second electrode stack 200c may be disposed on top of the first electrode stack 100c.

The first electrode stack 100c and the second electrode stack 200c may have a rectangular shape. For example, the first electrode stack 100c and the second electrode stack 200c are formed in a rectangular shape, and when viewed from above, three edges may overlap. In other words, the first electrode stack 100c and the second electrode stack 200c may be formed to have the same width but different heights when viewed from above.

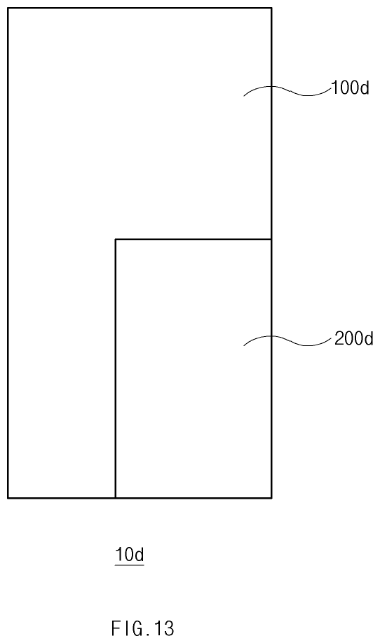

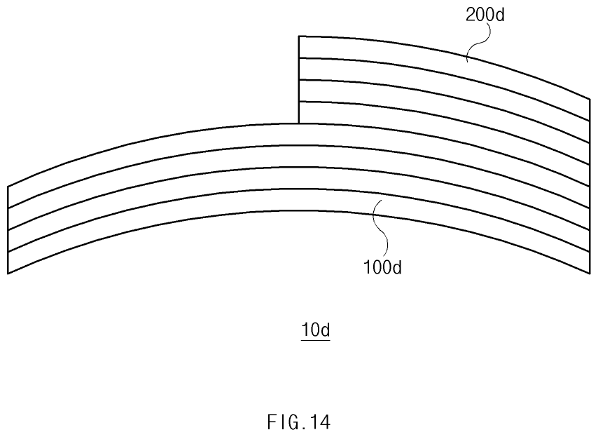

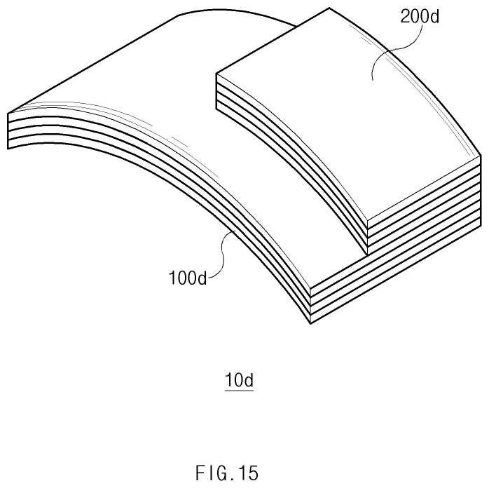

FIG. 13 is a plan view of an electrode stack according to a fifth aspect of the present disclosure, FIG. 14 is a side view of an electrode stack according to a fifth aspect of the present disclosure, and FIG. 15 is a perspective view of an electrode stack according to a fifth aspect of the present disclosure.

The electrode stack 10d may include a first electrode stack 100d and a second electrode stack 200d.

The second electrode stack 200d may be disposed on top of the first electrode stack 100d.

The first electrode stack 100d and the second electrode stack 200d may have a rectangular shape. Specifically, the first electrode stack 100d and the second electrode stack 200d are formed in a rectangular shape, and when viewed from above, two edges may overlap. In other words, the first electrode stack 100d and the second electrode stack 200d may be formed to have different widths and heights when viewed from above.

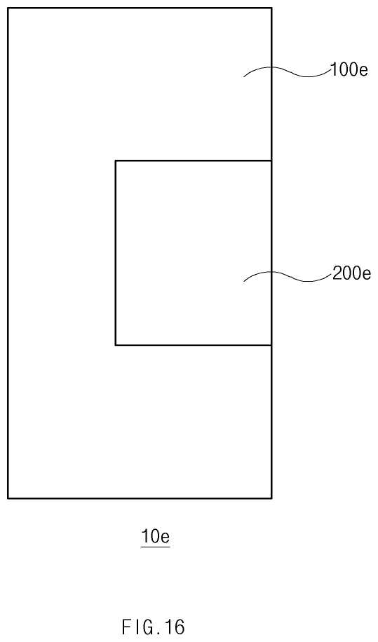

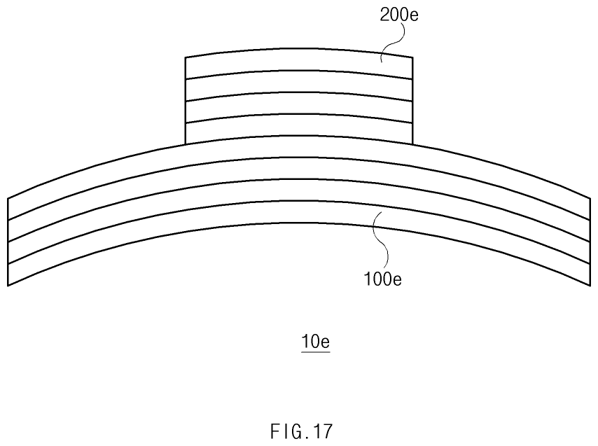

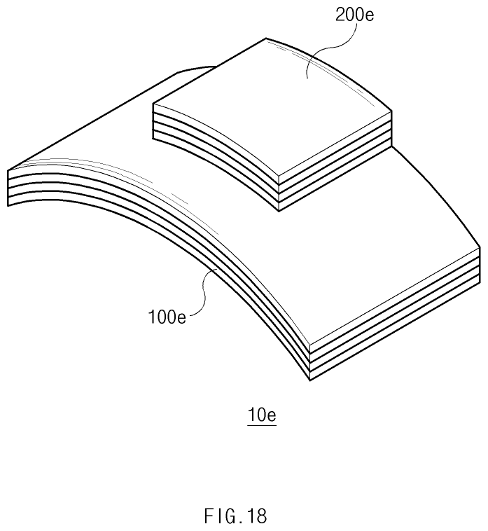

FIG. 16 is a plan view of an electrode stack according to a sixth aspect of the present disclosure, FIG. 17 is a side view of an electrode stack according to a sixth aspect of the present disclosure, and FIG. 18 is a perspective view of an electrode stack according to a sixth aspect of the present disclosure.

The electrode stack 10e may include a first electrode stack 100e and a second electrode stack 200e.

The second electrode stack 200e may be disposed on top of the first electrode stack 100e.

The first electrode stack 100e and the second electrode stack 200e may have a rectangular shape. Specifically, the first electrode stack 100e and the second electrode stack 200e are formed in a rectangular shape, and when viewed from above, one edge may overlap.

The description of the electrode stacks 10c, 10d, 10e described with reference to FIG. 10, FIG. 11, FIG. 12, FIG. 13, FIG. 14, FIG. 15, FIG. 16, FIG. 17, and FIG. 18 is an example and is not limited thereto. For example, the first electrode stack and the second electrode stack are formed in a rectangular shape, and when viewed from above, the edges may not overlap.

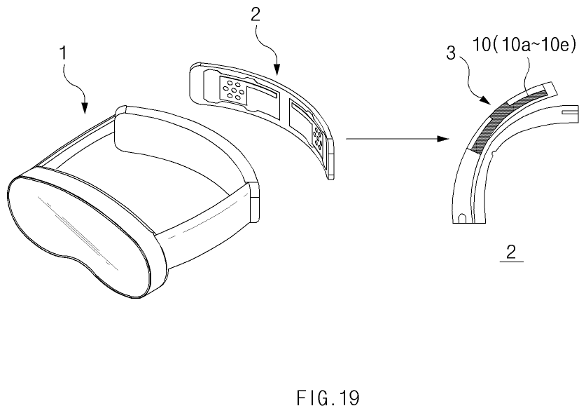

FIG. 19 is a conceptual view showing a battery system according to an aspect of the present disclosure. The description of the above-described aspect may also be applied equally or similarly to this aspect.

The battery system 1 may include a battery unit 2.

The battery unit 2 may perform the function of supplying power to the battery system 1. The battery unit 2 may accommodate the electrode stacks 10, 10a, 10b, 10c, 10d, 10e therein.

The battery unit 2 may include a bending portion 3. For example, the bending portion 3 may have a bent shape that defines a receiving space for accommodating the electrode stacks 10, 10a, 10b, 10c, 10d, 10e therein.

The battery unit 2 may include electrode stacks 10, 10a, 10b, 10c, 10d, 10e. The electrode stacks 10, 10a, 10b, 10c, 10d, 10e may be disposed in the receiving space of the bending portion 3. However, the electrode stacks 10, 10a, 10b, 10c, 10d, 10e may also be disposed at locations other than the bending portion 3.

One outer surface of the electrode stacks 10, 10a, 10b, 10c, 10d, 10e may be disposed to face the inner surface of the bending portion 3. For example, the upper surface of the electrode stacks 10, 10a, 10b, 10c, 10d, 10e may be disposed to face the inner surface of the bending portion 3. Additionally, the lower surface of the electrode stacks 10, 10a, 10b, 10c, 10d, 10e may be disposed to face the inner surface of the bending portion 3.

The bent inner surface of the bending portion 3 may include a portion bent at a predetermined curvature.

In the above description, the electrode stack is disposed, but it may be equally applied even when the electrode stack is embedded in a case and disposed.

A method of disposing the electrode stacks 10, 10a, 10b, 10c, 10d, 10e in the battery system 1 may include steps to be described later.

The method of disposing the electrode stacks 10, 10a, 10b, 10c, 10d, 10e in the battery system 1 may include a type determination step. The type determination step may be a step of determining the type of electrode stacks 10, 10a, 10b, 10c, 10d, 10e that may be disposed based on the size of the battery unit 2 in which the electrode stacks 10, 10a, 10b, 10c, 10d, 10e may be accommodated inside the battery system 1.

The method of disposing the electrode stacks 10, 10a, 10b, 10c, 10d, 10e in the battery system 1 may include a number determination step. The number determination step may be a step of determining the required number for each type of electrode stacks 10, 10a, 10b, 10c, 10d, 10e.

The method of disposing the electrode stacks 10, 10a, 10b, 10c, 10d, 10e in the battery system 1 may include a placement step. The placement step may be a step of disposing the electrode stacks 10, 10a, 10b, 10c, 10d, 10e based on the type determination and the number determination.

When the bent electrode stacks 10, 10a, 10b, 10c, 10d, 10e are disposed in a curved portion such as the bending portion 3 in the battery system 1, space efficiency may be maximized compared to a case where the unbent electrode stacks are simply stacked.

Space efficiency may be maximized by mixing the above-described bent electrode stacks 10, 10a, 10b, 10c, 10d, 10e with the unbent electrode stacks and disposing them in a manner that fits into the receiving space within the battery system 1.

When the space efficiency within the battery system 1 is maximized through the placement of the electrode stacks 10, 10a, 10b, 10c, 10d, 10e, the battery capacity may be maximized.

The present disclosure has been hereinabove described with regard to a limited number of aspects and drawings, but the present disclosure is not limited thereto and may be embodied in different forms by those having ordinary skill in the technical field pertaining to the present disclosure within the technical aspect of the present disclosure and the scope of the appended claims and their equivalents.

### List of Reference Numerals

1: Battery system
2: Battery unit
3: Bending portion
10, 10a, 10b, 10c, 10d, 10e: Electrode stack
100, 100a, 100b, 100c, 100d, 100e: First electrode stack
100-1, 100-1a, 100-1b: Electrodes
101, 101a: Side surface
102, 102a: Side surface
103, 103a: Side surface
104: Side surface
105: Side surface
111, 111a, 111b: Corner portion
112, 112a, 112b: Corner portion
113, 113a, 113b: Corner portion
114, 114a, 114b: Corner portion
115, 115a: Corner portion
200, 200a, 200b, 200c, 200d, 200e: Second electrode stack
200-1, 200-1a, 200-1b: Electrodes
201, 201a: Side surface
202, 202a: Side surface
203, 203a: Side surface
204, 204a: Side surface
205, 205a: Side surface
211, 211a, 211b: Corner portion
212, 212a, 212b: Corner portion
213, 213a, 213b: Corner portion
214, 214a, 214b: Corner portion
215, 215a, 215b: Corner portion

1. An electrode stack comprising:
a first electrode sub-stack; and
a second electrode sub-stack disposed on top of the first electrode sub-stack and formed in a different shape from the first electrode sub-stack when viewed from above the second electrode sub-stack,
wherein the first electrode sub-stack and the second electrode sub-stack are bent along a stacking direction.

2. The electrode stack according to claim 1,
wherein the second electrode sub-stack has a smaller size than the first electrode sub-stack.

3. The electrode stack according to claim 1,
wherein the first electrode sub-stack and the second electrode sub-stack are bent at a predetermined curvature.

4. The electrode stack according to claim 1,
wherein the first electrode sub-stack and the second electrode sub-stack are bent in one direction along the stacking direction.

5. The electrode stack according to claim 1,
wherein the second electrode sub-stack includes edges that overlap edges of the first electrode sub-stack.

6. The electrode stack according to claim 1,
wherein the second electrode sub-stack has a smaller area than the first electrode sub-stack when viewed from above the second electrode sub-stack.

7. The electrode stack according to claim 1,
wherein the first electrode sub-stack has a curved surface formed on a side surface thereof.

8. The electrode stack according to claim 7,
wherein at least one of the first electrode sub-stack or the second electrode sub-stack has corner portions formed in different shapes when viewed from above the second electrode sub-stack.

9. The electrode stack according to claim 8,
wherein the corner portions include a plurality of obtuse intersecting corner portions.

10. The electrode stack according to claim 8,
wherein the corner portions include:
a curved corner portion formed in the first electrode sub-stack; and
a plurality of obtuse intersecting corner portions formed in the second electrode sub-stack.

11. The electrode stack according to claim 8,
wherein the corner portions include:
an acute intersecting corner portion and an obtuse intersecting corner portion formed in the first electrode sub-stack; and
a plurality of obtuse corner portions formed in the second electrode sub-stack.

12. The electrode stack according to claim 1,
wherein the first electrode sub-stack and the second electrode sub-stack are bent in one direction along the stacking direction at a predetermined curvature, and
the second electrode sub-stack has a smaller area in a different shape from the first electrode sub-stack when viewed from above the second electrode sub-stack.

13. A battery system comprising:
a battery unit having a bending portion in a bent shape that defines a receiving space for accommodating an electrode stack therein; and
an electrode stack disposed in the receiving space,
wherein the electrode stack includes:
a first electrode sub-stack; and
a second electrode sub-stack disposed on top of the first electrode sub-stack and formed in a different shape from the first electrode sub-stack when viewed from above the second electrode sub-stack,
wherein the first electrode sub-stack and the second electrode sub-stack are bent along a stacking direction.

14. The battery system according to claim 13,
wherein the electrode stack is bent at a predetermined curvature along the stacking direction.

15. The battery system according to claim 13,
wherein one outer surface of the electrode stack faces an inner surface of the bending portion.

16. The battery system according to claim 13,
wherein the second electrode sub-stack has a smaller area than the first electrode sub-stack when viewed from above the second electrode sub-stack.
